(19) United States
(12) Patent Application Publication
(10) Pub. No.: US 2018/0200957 A1
(43) Pub. Date: Jul. 19, 2018

(54) Monitoring A Process For Powder-Bed Based Additive Manufacturing

(71) Applicant: Siemens Aktiengesellschaft, Muenchen (DE)

(72) Inventors: Ursus Krüger, Berlin (DE); Oliver Stier, Berlin (DE)

(73) Assignee: Siemens Aktiengesellschaft, Muenchen (DE)

(21) Appl. No.: 15/742,667

(22) PCT Filed: Jul. 4, 2016
(86) PCT No.: PCT/EP2016/065660

§ 371 Date: Jan. 8, 2018

(30) Foreign Application Priority Data
Jul. 9, 2015 (DE) 10 2015 212 837.7

(51) Int. Cl. B29C 64/386; G01N 21/95; B29C 64/153; B33Y 10/00; B33Y 30/00; B33Y 50/00; B29C 64/20

(52) U.S. Cl. CPC B29C 64/386; G01N 21/95; B29C 64/153; B29C 64/20; B33Y 30/00; B33Y 50/00; B33Y 10/00

(57) ABSTRACT

The present disclosure relates powder-bed-based additive manufacturing of a component in a powder bed. For example, a method for monitoring a process for powder-bed-based additive manufacturing of a component in a powder bed may include: using an image sensor to image a surface of the powder bed; illuminating the surface of the powder bed diagonally from above from at least one direction by a light source; and evaluating an image depicted on the image sensor to monitor the surface of the powder bed.

### CROSS-REFERENCE TO RELATED APPLICATIONS

This application is a U.S. National Stage Application of International Application No. PCT/EP2016/065660 filed Jul. 4, 2016, which designates the United States of America, and claims priority to DE Application No. 10 2015 212 837.7 filed Jul. 9, 2015, the contents of which are hereby incorporated by reference in their entirety.

### TECHNICAL FIELD

The present disclosure relates powder-bed-based additive manufacturing of a component in a powder bed.

### BACKGROUND

Additive manufacturing methods for manufacturing components may include additive manufacturing methods which are powder-bed-based. The component is manufactured layer-by-layer from a powder bed, wherein a layer of powder having a constant thickness is applied in each case in the powder bed and subsequently this powder is melted or sintered using an energy source, to create a layer of the component to be manufactured in the powder bed. The energy source may generate a laser beam or an electron beam for this purpose. For example, selective laser melting (SLM) and selective laser sintering (SLS) are laser-based methods. Electron beam melting (EBM) is an electron-beam-based method.

The layers of the powder bed may be doctored. This means that a doctor blade is drawn with its doctor blade lip over the surface of the powder bed and said surface is thus smoothed and a defined level thereof is set. During this doctoring, larger clumps of powder can cause line defects. Line defects are formed in the surface of the powder bed as furrows. Furthermore, the above-mentioned clumps may come to rest in the powder bed and might be raised in comparison to the surface of the powder bed and/or create craters in the direct surroundings thereof in the surface of the powder bed. The clumps in the powder bed occur, for example, in that during the melting of the powder layer, sprays of molten powder particles are thrown away from the laser beam into the powder bed.

The described defects, in particular the line defects, can result, in the manufacturing step of the component by the laser or the electron beam, in defects in the formed layer of the component, which defects can no longer be compensated for in the further course of the method and can therefore result in a discarding of the component to be created. High costs result as a consequence, in particular if the component is already almost finished. In general, optical methods are used for monitoring surfaces, which do not supply reliable results with respect to an examination of the created powder bed because of the diffuse surface of the powder bed.

### SUMMARY

The teachings of the present disclosure may enable a method for monitoring a process for powder-bed-based additive manufacturing, to identify flaws in the surface of the powder bed. In addition, some embodiments may include a system for powder-bed-based additive manufacturing of a component, using which system monitoring of the surface of the powder bed can be carried out reliably.

For example, some embodiments may include a method for monitoring a process for powder-bed-based additive manufacturing of a component (16) in a powder bed (14), characterized in that an image sensor (31) is used, on which a surface (21) of the powder bed (14) is imaged using an optical unit (32), while the surface (21) of the powder bed (14) is illuminated diagonally from above from at least one direction by at least one light source (34) and an image depicted on the image sensor is evaluated to monitor the surface (21) of the powder bed.

In some embodiments, the image sensor (31) is arranged vertically above the powder bed, wherein the optical axis of the optical unit (32) is perpendicular to the surface (21) of the powder bed (14).

In some embodiments, the resolution of the image sensor (31) is selected such that a plurality of particles, preferably 10, more preferably 50 particles of the powder used are depicted in a pixel of the generated image of the powder bed.

In some embodiments, the alignment of a pixel array of the image sensor (31) in relation to the movement direction (25) of a doctor blade (19) for smoothing the powder bed (14) is pivoted by an angle between 30° and 60° about the optical axis of the optical unit (32).

In some embodiments, the light source (34) is arranged such that an illumination direction (35), seen in a viewing direction perpendicular to the surface of the powder bed (14), deviates from the movement direction (25) of a doctor blade (19) for smoothing the powder bed (14).

In some embodiments, said illumination direction (35) of the light source (34) is at an angle of 80° to 100° to the movement direction (25) of the doctor blade (19).

In some embodiments, the illumination is illuminated by means of multiple light sources (34) in multiple illumination directions (35) which differ from one another viewed in a viewing direction perpendicular to the surface of the powder bed (14).

In some embodiments, the light source (34) or the multiple light sources (34a, 34b, 34c, 34d, 34e, 34f, 34g) emits or emit light in a wavelength spectrum which differs from the spectrum of the thermal radiation of the heated powder bed (14) and that of the component (16) currently being manufactured.

In some embodiments, the light source (34) emits monochromatic light or multiple light sources (34) emit monochromatic light having different wavelengths in each case.

In some embodiments, the image sensor (31) is insensitive to the spectrum of the thermal radiation of the heated powder bed (14) and that of the component (16) currently being manufactured or a filter (38) is provided in the optical unit (32) for the spectrum of the thermal radiation of the heated powder bed (14) and that of the component (16) currently being manufactured.

In some embodiments, the surface (21) of the powder bed (14) is imaged using the optical unit (32) on the image sensor before the surface (21) of the powder bed (14) is illuminated by the at least one light source (34), thereafter the surface (21) of the powder bed (14) is imaged using the optical unit (32) on the image sensor, while the surface (21) of the powder bed (14) is illuminated diagonally from above from at least one direction by at least one light source (34), and thereafter, the image of the surface (21) without illumination is subtracted from the image of the surface (21) with illumination during the evaluation.

In some embodiments, the powder bed (14) is examined for the presence of furrows (36), and the process is interrupted if a furrow (36) is recognized in the powder bed.

In some embodiments, the process is only interrupted if the recognized furrow (36) is located in a region of the powder bed (14) in which the layer of the component (16), which layer is currently to be manufactured, lies.

In some embodiments, the surface of the component currently being created is also examined for irregularities.

As another example, some embodiments may include a system for the powder-bed-based additive manufacturing of a component, comprising a receptacle device (13) for a powder bed (14), which device is arranged in a process chamber (12), characterized in that an optical monitoring unit (30) is provided, which device comprises an image sensor (31) and an optical unit (32) oriented toward the receptacle device (13), and at least one light source (34) is arranged diagonally above the receptacle device in the process chamber (12), using which light source the receptacle device can be directly illuminated.

### BRIEF DESCRIPTION OF THE DRAWINGS

Further details will be described hereafter on the basis of the drawing. Identical or corresponding elements of the drawing are each provided with identical reference signs and are only explained multiple times if differences result between the individual figures. In the figures:

FIG. 1 shows an exemplary embodiment of the system in schematic section, according to the teachings of the present disclosure;

FIG. 2 shows an exemplary embodiment of the method, according to the teachings of the present disclosure;

FIGS. 3 and 4 show top views of the surface of a powder bed according to FIG. 2 with different illumination directions, according to the teachings of the present disclosure; and

FIG. 5 schematically shows an image which was ascertained by an evaluation in the method according to FIG. 2.

### DETAILED DESCRIPTION

In some embodiments, an image sensor is used, on which a surface of the powder bed is imaged using an optical unit, while the surface of the powder bed is illuminated diagonally from above from at least one direction by at least one light source. Using the image sensor, a digital image of the surface is then generated, wherein defects in the surface can be clearly recognized by means of shadowing, since the light source illuminates the surface of the powder bed diagonally from above. This means that the angle of the illuminating light in relation to the surface of the powder bed is not equal to 90°. The illumination angle is advantageously <45°, and still more preferably the illumination angle is <30°.

In some embodiments, the generated image enables an evaluation according to the so-called shape from shading method, as is described in detail in EP 2 006 804 A1. The method may include using an algorithm, with which an image depicted on the image sensor can be evaluated to monitor the surface of the powder bed. The evaluation result may be used in the method sequence for the purpose of generating a decision criterion as to whether the method is interrupted to initiate quality-ensuring measures. These can consist, for example, of an inadequate surface of the powder bed being improved by repeated doctoring thereof.

For example, if a clump has been transported to the edge of the powder bed by the doctoring, this clump then subsequently no longer generates effects in the surface of the powder bed. If the contaminations due to clumps in the surface of the powder bed have become excessively large, then, for example, the powder bed can be entirely or partially removed from the receptacle device for the powder and the powder bed can be rebuilt using non-contaminated powder. In any case, the quality of the component to be manufactured will not suffer in the subsequent manufacturing step if an intact surface of the powder bed is manufactured. A discarding of components because of a poor quality of the surface of the powder bed can therefore be substantially reduced and/or avoided. The method may be so reliable that at least defects in the surface of the powder bed, which, in the size thereof, would endanger the quality of the component to be manufactured, are reliably recognized. Smaller defects in the surface of the powder bed, which are not recognized by the method according to the invention for monitoring, are typically so minor that they do not influence the quality of the component.

In some embodiments, the image sensor is arranged vertically above the powder bed, wherein the optical axis of the optical unit is perpendicular to the surface of the powder bed. This has the advantage that the image of the surface can be generated substantially distortion-free and having a high definition over the entire image surface, which advantageously influences the recognition of defects.

In some embodiments, the resolution of the image sensor is selected such that a plurality of particles, 10, or 50 particles of the powder used are depicted in one pixel of the generated image, wherein typically powders having an interval for the particle sizes occurring in the powder of between 10 and 50 μm are used (the mass-weighted mean value of the particle size is between 20 and 30 μm in this case). In other words, to carry out the monitoring method, a comparatively cost-effective image sensor can advantageously be used, since the resolution can remain well below the mean particle size depicted on the image sensor. This is because the defects in the surface of the powder bed have to be larger than the particles. In some embodiments, the resolution of the image sensor is selected in the above-mentioned manner, since the texture of the surface of the flawless powder bed cannot be misinterpreted as a defect in the surface in this manner. Thus, no measures are necessary for image processing, to preclude a mistaken detection of the texture of the powder bed as a flaw, if the resolution of the image sensor is correctly selected.

In some embodiments, the alignment of a pixel array of the image sensor in relation to the movement direction of a doctor blade for smoothing the powder bed is pivoted about the optical axis of the optical unit by an angle between 30° and 60°. Since the movement direction of the doctor blade over the surface of the powder bed is the cause of the occurrence of the furrows already described above, they are normally aligned precisely in the movement direction of the doctor blade. If the pixel array is pivoted in relation to this alignment of the furrows, the probability that the furrow will encounter pixels of the image sensor is advantageously increased, so that a thin line, as can be optically generated by the furrow, can be more easily recognized. An angle of 45° may be selected for the pivoting of the image sensor.

In some embodiments, the light source is arranged such that an illumination direction deviates from the movement direction of a doctor blade for smoothing the powder bed. In this case, the illumination direction should be understood as being in a viewing direction perpendicular to the surface of the powder bed, in other words, the directional component of the illumination which can be measured in a vertical projection on the surface of the powder bed. If the illumination direction of the light source deviates from the movement direction of the doctor blade, furrows that have occurred and have their extension precisely in the movement direction of the doctor blade are then also advantageously more easily detected by strong shadowing, since the shadow thereof is more pronounced on the image sensor. Said illumination direction of the light source is advantageously aligned at an angle of 80°-100°, in particular an angle of 90° in relation to the movement direction of the doctor blade is selected. In this manner, the shadowing may be maximized because of the above-mentioned effect.

In some embodiments, the illumination is illuminated by means of multiple light sources in multiple illumination directions. These multiple illumination directions differ from one another viewed in a viewing direction perpendicular to the surface of the powder bed. This means that each of the light sources generates a different shadow of the defects. The light sources can then be activated in succession, for example, so that various shadows can be evaluated individually and in a second step the items of information thus obtained can be combined, so that by way of a common evaluation of the generated items of information, the reliability of the recognition of defects in the surface of the powder bed advantageously increases.

In some embodiments, the light source or the multiple light sources emits or emit light in a wavelength spectrum which differs from the spectrum of the thermal radiation of the heated powder bed and that of the component currently being manufactured. In this way, it is possible that even in the event of intensive process reflection of heat because of the thermal conditions in the powder bed, shadowing of defects can be reliably recognized, since it is not outshone by the temperature radiation of the component and of the powder bed.

In particular, the light source can emit monochromatic light or multiple light sources can each emit monochromatic light having different wavelengths in each case, wherein these wavelengths, as already mentioned, are outside the spectrum of the thermal radiation. The thermal radiation involves wavelengths of the blackbody radiation up to 1500° C., whereby even the light of the molten powder can be reliably differentiated from the examination light.

In some embodiments, the image sensor is insensitive to the spectrum of the thermal radiation of the heated powder bed and that of the component currently being manufactured. In this way, it is possible to avoid the light of the thermal radiation being detected at all by the image sensor. Another possibility is that a filter for the spectrum of the thermal radiation of the heated powder bed and that of the component currently being manufactured is provided in the optical unit. This means that the thermal radiation is filtered out by the filter and only the measuring light arrives at the image sensor.

In some embodiments, the heated powder bed can be recorded using the image sensor without illumination by the light source, to eliminate the component of the thermal radiation of the powder bed. The surface of the powder bed is imaged using the optical unit on the image sensor, before the surface of the powder bed is illuminated by the at least one light source, and thereafter the surface of the powder bed is imaged once again using the optical unit on the image sensor, while the surface of the powder bed is illuminated from at least one direction diagonally from above by at least one light source. An image is prepared from both depictions and thereafter the image of the surface without illumination is subtracted from the image of the surface with illumination during the evaluation. Subsequently, an image remains having the illumination component of the light source for judging the shadowing of possible defects in the surface of the powder bed.

In some embodiments, it can also be taken into consideration in the evaluation of the images whether a recognized furrow is located in a region of the powder bed in which the layer of the component, which layer is currently to be manufactured, lies. The process is then only interrupted if this is the case, since the manufacturing result of the component is only then endangered. If the furrow lies in a subregion where the powder of the present layer is not to be melted, in a subsequent application step of powder using the doctor blade, it can be examined whether the disturbance of the surface is compensated for or whether it was transported into a part of the powder bed where the manufacturing of the component is endangered. The areas which are to be melted by the laser beam in the powder bed may be ascertained easily by the evaluation of the process control for manufacturing the component, since said areas have to be known in any case.

In some embodiments, the surface of the component currently being created is also studied for irregularities. In this case, the same algorithms are applicable as are used for the powder bed. However, a further optical examination step is necessary, which is carried out before the application of a new layer of the powder. Using this monitoring step, unforeseen flaws in the currently manufactured surface of the component layer may be established, so that it can be decided whether these flaws have to result in a discarding of the component and further manufacturing expenditure can be saved for a component which would otherwise have to be rejected only at the end as a discard.

In some embodiments, an image sensor is provided, using which sensor the above-mentioned method can be carried out. Moreover, light sources are provided, so that the above-mentioned method can be carried out. The advantages linked to the operation of the system according to the invention have already been explained in detail above.

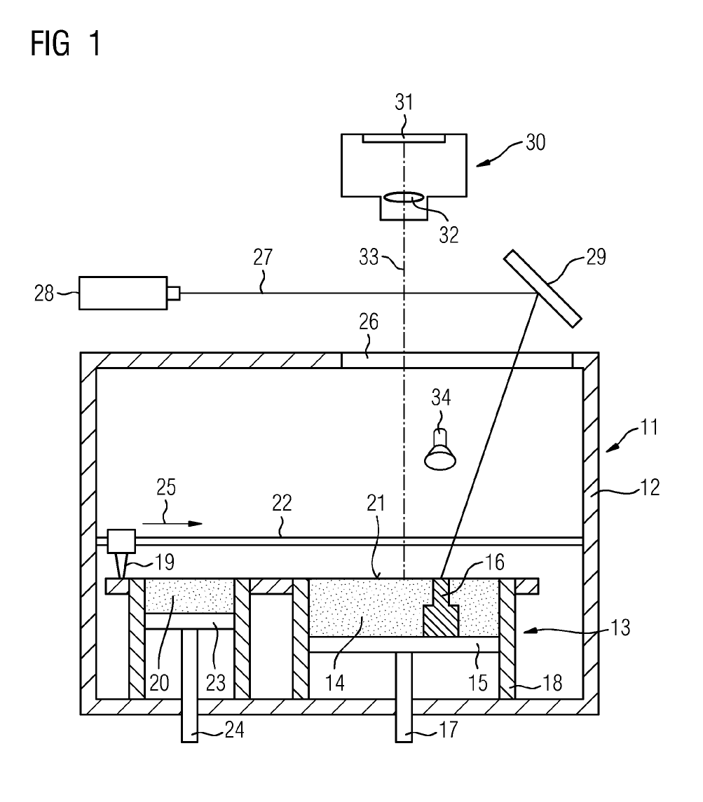

FIG. 1 shows an example system 11 for selective laser melting. Said system has a process chamber 12 with a receptacle device 13 for a powder bed 14. This receptacle device 13 consists of a construction platform 15 on which a component 16 can be manufactured. The construction platform 15 can be lowered via a cylinder 17, wherein side walls of the receptacle device 13 ensure that the powder bed 14 finds a hold toward the side.

The powder bed 14 is smoothed layer-by-layer by a doctor blade 19, wherein this doctor blade 19 is firstly guided over a powder store 20 and subsequently over a surface 21 of the powder bed 14. Because the construction platform 15 is lowered step-by-step, new layers of the powder bed 14 can be created by the doctor blade 19, wherein the latter is moved via a guide rail 22. In order that the doctor blade can entrain powder from the powder store 20 in this case, a bottom plate 23 is mounted so as to be vertically displaceable via a further cylinder 24. The guide rail 22 determines a movement direction 25 for the doctor blade 19 in this case.

A window 26 is provided in the wall of the process chamber 12, through which window a laser beam can pass, which is generated by a laser 28 arranged outside the process chamber 12. This laser can be moved on the surface 21 of the powder bed 14 via a deflection mirror 29, whereby the areas of the surface 21 from which the component 16 is to be manufactured layer-by-layer can be melted.

Moreover, a monitoring unit 30 is provided outside the process chamber 12, which monitoring unit comprises an image sensor 31 and an optical unit 32. The monitoring unit 30 is arranged above the surface 21 of the powder bed 14 such that an optical axis 33 of the optical unit 32 is precisely perpendicular to the surface 21. To be able to record an image, which depicts the surface 21, by means of the image sensor 31, a light source 34, for example in the form of an LED headlight, is furthermore arranged in the process chamber 12, which light source can illuminate the surface 21 of the powder bed 14.

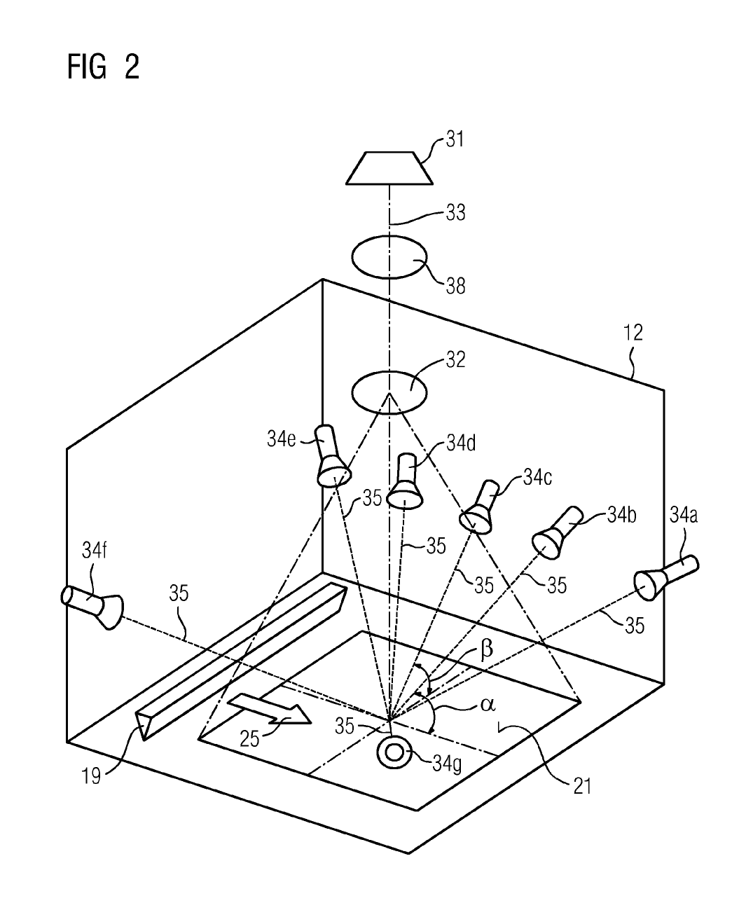

The method for monitoring the surface 21 of the powder bed can be explained in greater detail on the basis of FIG. 2. Multiple light sources 34a to 34g can be seen in FIG. 2, to explain various illumination methods. In a system according to FIG. 1, all of these light sources do not have to be accommodated at once, but accommodating multiple light sources enables a variation of the illumination while the monitoring method is carried out. For example, the light sources 34a, 34e, 34f, and 34g can be used to enable an illumination of the surface 21 from four illumination directions 35 perpendicular to one another. In this way, particular flaws in the surface 21 may be ascertained which are not in the form of a furrow, but rather, for example, in the form of craters or powder clumps.

Furthermore, the light sources 34b, 34c, 34d, illuminate the surface 21 of the powder bed from the side with respect to the movement direction 25 of the doctor blade 19. The light source 34c has an illumination direction of 90° in relation to the movement direction 25 in this case, wherein this angle is measured in a viewing direction from above, precisely in the direction of the optical axis 33. This angle is indicated as the angle α in the surface 21 in FIG. 2. Furthermore, an angle of inclination β can be inferred from FIG. 2, which angle indicates at which angle the illumination takes place diagonally from above.

Both angles are shown for the illumination direction 35 of the light source 34c. In the case of the light sources 34b and 34d, angles α of 105° and 75°, respectively, result (not shown in FIG. 2). By alternating illumination by means of the light sources 34b and 34d, and possibly also 34c, a modified shadowing of flaws in the surface 21 can be generated, whereby a reliability of the recognition of flaws is increased by superposition of the images thus created. Instead of activating the light sources 34a to 34g in succession, these or at least some of them can also emit monochromatic light of different wavelengths and be operated simultaneously. The signals on the image sensor can then be studied separately from one another because of the different wavelengths, even if they are incident simultaneously on the image sensor 31.

Furthermore, it can be inferred from FIG. 2 that the image sensor 31 is pivoted with respect to its alignment by precisely 45° in the optical axis 33 in relation to the surface 21 of the powder bed. The detection of flaws can be improved in this way, as explained in greater detail hereafter with reference to FIG. 5.

In order that the light signals originating from the surface 21 due to the illumination by the light sources 34a to 34g can be evaluated separately from thermal radiation, a filter 38 is provided, which also lies in the optical axis 33. As a result, the spectra of the thermal radiation, which can be significant because of the heat arising in the process and which can outshine the measuring signals due to the illumination by the light sources 34a to 34g, can remain unconsidered during the measurement. This enables a more reliable evaluation of the measurement signals.

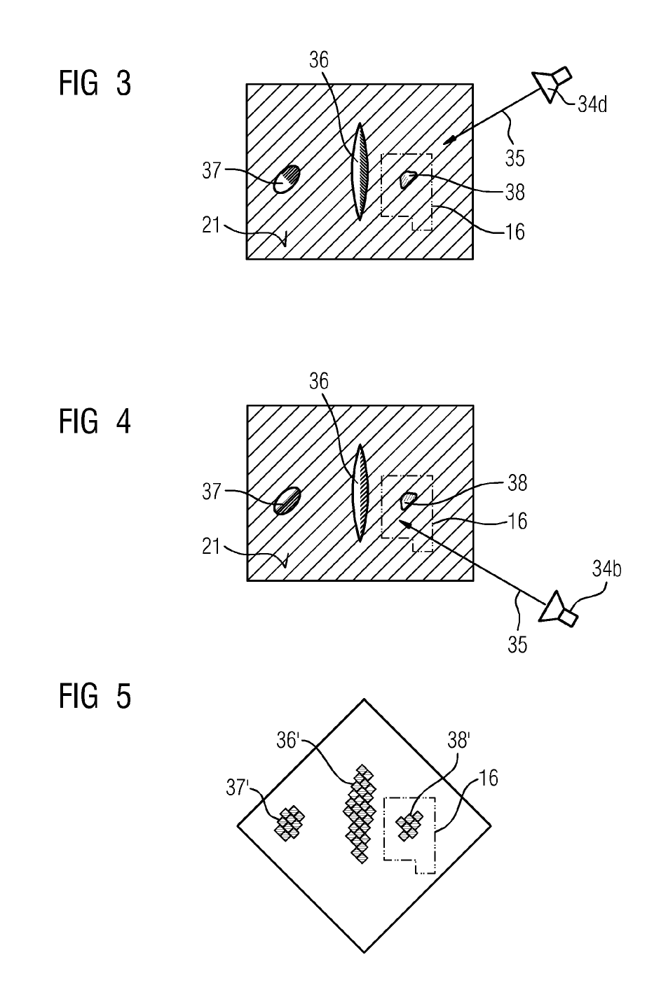

It can be seen from FIGS. 3 and 4 how the surface 21 of the powder bed is illuminated by the light sources 34b and 34d from different illumination directions 35. A furrow 36 is shown in FIGS. 3 and 4, as is produced when a powder clump is drawn through the powder bed by the doctor blade 19 (cf. FIG. 2). In addition, a crater 37 is shown, which can arise when a powder clump is torn out of the powder bed. This represents, as an example, a punctiform defect of the surface 21. Lastly, a powder clump 38 is shown, which also represents a punctiform defect and protrudes out of the surface 21 of the powder bed. Lastly, the contour of the component 16 currently being manufactured may be seen, which contour cannot be seen during manufacturing of a new layer of the powder bed, since the component is completely covered by this layer.

The shading in FIGS. 3 and 4 is intended to illustrate a brightness of the illuminated surface. The powder bed appears on its surface 21 in a diffusely distributed light intensity, while a denser shading indicates the shadowing of the crater 37, the furrow 36, and the powder clump 38. Other areas of the above-mentioned defects, in contrast, are illuminated almost vertically and therefore appear without shading. If one compares FIGS. 3 and 4 to one another, it is shown that because of the different illumination directions 35, the shadowing varies, which is helpful in the judgment of the three-dimensional extension of the various flaws.

FIG. 5 shows how an evaluation can be performed from the image recorded using the image sensor 31 according to FIG. 2, which evaluation can be displayed, for example, on an output unit of a display screen. The defects 36′, 37′, and 38′ can be seen, wherein the individual pixels of the image sensor are indicated. These are shown in exaggeratedly large form in FIG. 5 by way of example, to illustrate this effect. Because of the pivoting of the image sensor 31 in relation to the surface 21 of the powder bed by 45° described in relation to FIG. 2, a larger number of pixels is taken up by the furrow 36, for example, by means of the shadowing and/or the direct illumination, whereby the image sensor reacts more sensitively to the illumination and the shadowing of the areas in the furrow.

In addition, the contour of the component 16 is overlaid in FIG. 5, wherein said contour is computed from the component data (CAD model) available in the process. Proceeding therefrom, a decision can be made as to whether the powder clump 38 (i.e., 38′ in FIG. 5) has a size which impairs the component result and as a result a new smoothing attempt of the surface 21 is to be undertaken using the doctor blade 19. Furthermore, it becomes clear from an evaluation of the result according to FIG. 5 that the furrow 36 and the crater 37 are located outside the component 16, which immediately becomes clear by means of the judgment of the depictions 36′ and 37′ thereof.

What is claimed is:

1. A method for monitoring a process for powder-bed-based additive manufacturing of a component in a powder bed, the method comprising:
using an image sensor to image a surface of the powder bed;
illuminating the surface of the powder bed diagonally from above from at least one direction by a light source; and
evaluating an image depicted on the image sensor to monitor the surface of the powder bed.

2. The method as claimed in claim 1, wherein the image sensor is arranged vertically above the powder bed;
wherein an optical axis of the image sensor is perpendicular to the surface of the powder bed.

3. The method as claimed in claim 1, wherein a resolution of the image sensor allows a plurality of particles to be depicted in a pixel of the image.

4. The method as claimed in claim 1, wherein an alignment of a pixel array of the image sensor in relation to the movement direction of a doctor blade for smoothing the powder bed is pivoted by an angle between 30° and 60° about the optical axis of the optical unit.

5. The method as claimed in claim 1, wherein the light source is arranged such that an illumination direction, seen in a viewing direction perpendicular to the surface of the powder bed, deviates from the movement direction of a doctor blade for smoothing the powder bed.

6. The method as claimed in claim 5, wherein said illumination direction of the light source is at an angle of 80° to 100° to the movement direction of the doctor blade.

7. The method as claimed in claim 1, wherein the illumination is provided by means of multiple light sources in multiple illumination directions differing from one another viewed in a viewing direction perpendicular to the surface of the powder bed.

8. The method as claimed in claim 1, wherein the light source emits light in a wavelength spectrum which differs from the spectrum of the thermal radiation of the heated powder bed and that of the component currently being manufactured.

9. The method as claimed in claim 8, wherein the light source emits monochromatic light or multiple light sources emit monochromatic light having different wavelengths in each case.

10. The method as claimed in claim 8, wherein the image sensor is insensitive to the spectrum of the thermal radiation of the heated powder bed and that of the component currently being manufactured.

11. The method as claimed in claim 8, further comprising:
imaging the surface before the surface of the powder bed is illuminated by the light source;
thereafter imaging the surface while the surface is illuminated diagonally from above from at least one direction by at least one light source; and
subtracting the image of the surface without illumination from the image of the surface with illumination during the evaluation.

12. The method as claimed in claim 1, further comprising examining the powder bed for the presence of furrows; and
interrupting the process if a furrow is recognized in the powder bed.

13. The method as claimed in claim 12, wherein the process is only interrupted if the recognized furrow is located in a region of the powder bed in which the layer of the component currently to be manufactured lies.

14. The method as claimed in claim 1, further comprising examining the surface of the component currently being created for irregularities.

15. A system for powder-bed-based additive manufacturing of a component, the system comprising:
a receptacle device for a powder bed, the receptacle device arranged in a process chamber;
an optical monitoring unit comprising an image sensor and an optical unit oriented toward the receptacle device; and
a light source arranged diagonally above the receptacle device in the process chamber;
wherein the light source directly illuminates the receptacle device.

16. The method as claimed in claim 8, wherein a filter of the optical unit blocks light from the spectrum of the thermal radiation of the heated powder bed and that of the component currently being manufactured.
